(19) United States
(12) Patent Application Publication
(10) Pub. No.: US 2018/0333239 A1
(43) Pub. Date: Nov. 22, 2018

(54) Computerized Toothbrush

(71) Applicant: Ashley Wen, Redwood Shores, CA (US)

(72) Inventor: Ashley Wen, Redwood Shores, CA (US)

(73) Assignee: Ashley Wen, Redwood Shores, CA (US)

(21) Appl. No.: 15/596,019

(22) Filed: May 16, 2017

(51) Int. Cl. A61C 17/20; A46B 9/04; A61C 17/22; A61C 17/32; A46B 13/00

(52) U.S. Cl. CPC A61C 17/20; A46B 9/045; A46B 5/0075; A61C 17/32; A46B 13/001; A61C 17/228

(57) ABSTRACT

A dental cleaning device includes a bite plate to clamp an upper and a lower arch in a predetermined bite position; a track fixed to the bite plate to provide a dental arch movement; and a carrier holding dental instruments thereon and moving along the track.

### FIELD OF THE INVENTION

The present invention relates to methods and apparatuses for a computerized electronic toothbrush and more specifically to methods and apparatuses for the usage of computers to make customized hands-free electronic toothbrushes tailored to individual users' mouth shapes.

### BACKGROUND OF THE INVENTION

People typically undergo long and detailed processes in order to maintain oral hygiene. With the current popular innovation of the electric toothbrush, users are still recommended to spend at minimum two minutes brushing their teeth. Further, users may be instructed to brush specific areas of their teeth for longer periods of time, and to take other measures such as flossing to compensate for insufficient brushing technique and overall oral care.

Due to the time and tedium required by the traditional processes used to maintain oral hygiene, many people do not or cannot brush their teeth properly. For example, the elderly, disabled, and children may lack certain skills necessary to properly brush their teeth. Also, those fully capable of brushing their teeth are oftentimes too busy to dedicate the necessary time to properly do so.

To address the aforementioned issues, hands-free tooth-cleaning devices have been developed, reducing user involvement in the teeth-cleaning process. For example, U.S. Pat. No. 4,237,574 to Kelly et al. and U.S. Pat. No. 2014/0093836A1 to Wolpo et al. each describe hands-free toothbrush devices that consist of a U-shaped mouthpiece, mounted with brushes, which utilizes ultrasonic vibratory mechanisms to brush the user's teeth. However, this conventional design of hands-free tooth-cleaning devices does not take into account the necessary pressure normally applied by the user's hand in brushing his/her teeth. Thus, this design is unable to thoroughly clean the teeth's surfaces, the primary objective of a tooth-cleaning device. This design also does not account for customization, preventing users or their dentists from focusing on specific areas of the teeth that may require more work. With regards to plaque deposits, this design's bristle is usually wide and long, thus not adaptive to tooth crevices, making it difficult to reach the crevices between each tooth, leaving them poorly brushed. Further, this design requires the user to insert a bulky, rather large device in his/her mouth, which causes the user great discomfort.

Another design for a hands-free toothbrush is a singular device comprised of two U-shaped carriers, in which one is for the top teeth and the other, for the bottom. For example, CN 201210405105 to Hang Yu describes a design of U-shaped carriers that wrap around the user's teeth from front to back. These carriers, mounted with brushes, travel along the user's teeth structure. This design fails to take into account the variability in width of teeth. Thus, whereas the U-shaped carrier may fit one tooth perfectly, it may be too narrow or tooth wide to properly brush another. Also, the U-shaped design prevents the existence of brushes for the occlusal surfaces of the teeth. A user would have to find alternate means to brush this area of his/her teeth.

### SUMMARY OF THE INVENTION:

In one aspect, a cleaning device includes a bite plate to clamp an upper and a lower arch in a predetermined bite position; a track fixed to the bite plate to provide a dental arch movement; and a carrier holding dental instruments thereon and moving along the track.

In another aspect called Arc, a hands-free toothbrush device BRUSHES a user's teeth with mechanisms similar to those of an auto car wash, with each tooth being analogous to a car. Unlike a car wash, this hands-free toothbrush device is customized to brush on a path that follows each individual's dentition shape, utilizing brushing properties that are further customizable by the user or his/her dentist with an electronic device.

Advantages of the system may include one or more of the following. The system provides a convenient and quick brushing solution for teeth cleaning. Other advantages may include:

hands-free—suitable for disabled, elderly, kids, busy people

fast and effective brushing solution for teeth cleaning

precise/concise—smaller brush heads make it easier to reach embrasure areas

customizable framework by dentists.

### BRIEF DESCRIPTION OF THE FIGURES

FIG. 1 shows an exemplary bite plate.

FIG. 2 shows two embodiments for the bite plate while FIG. 3 shows two exemplary side views of these embodiments.

FIG. 4 shows an extension to the BITE PLATE.

FIG. 5 shows the relationship between the CARRIERS and a TRACK.

FIG. 6 shows the CARRIERS as placed on the teeth.

FIG. 7 shows a comparison of the conventional toothbrush and the device's BRUSH.

FIG. 8 shows two embodiments for how the bristles of the BRUSHES may rotate.

FIG. 9 shows an exemplary process to make a BITE PLATE and TRACK customized to an individual's dentition shape

FIG. 10 shows the whitening device by replacing the BRUSHES on the CARRIERS with nozzles, which can precisely apply whitening chemicals to the user's teeth surfaces.

FIG. 11 shows the mouth-washing and rinsing device by replacing the BRUSHES on the CARRIERS with water jet nozzles to apply water or a mouth-washing liquid to the user's teeth surfaces.

FIG. 12 shows the drainage device, which is placed inside the BITE PLATE to rid of excess liquid in the user's mouth.

FIG. 13 shows the flossing device.

FIG. 14 shows an exemplary gum-washing device.

FIG. 15 shows the brushing device customized for users with braces or retainers.

FIG. 16 shows an exemplary drug delivery device.

FIGS. 17-18 show screenshots of an exemplary application in which the dentist can control brushing time for a specific area of the user's teeth.

### DESCRIPTION

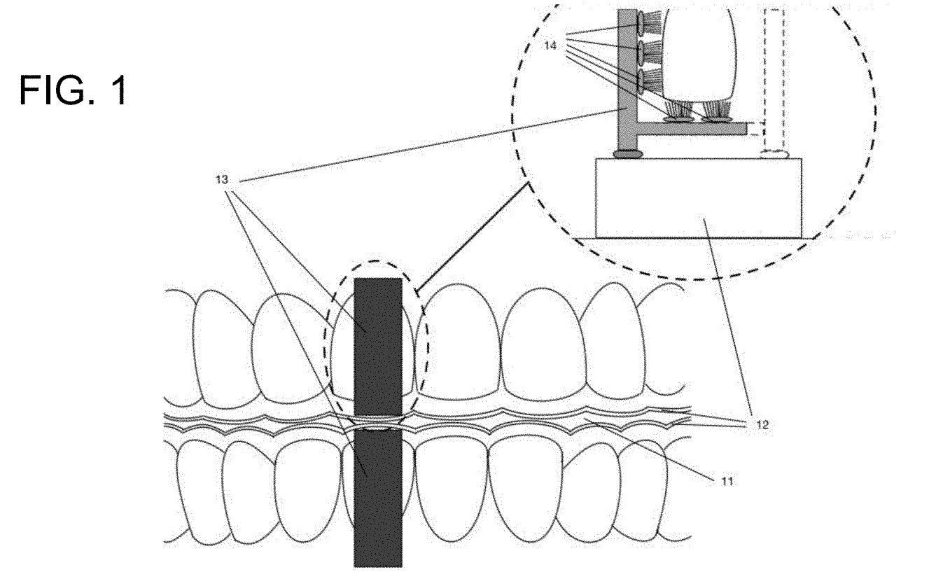

FIG. 1 shows an exemplary bite plate with the following components:
1. BITE PLATE 11, a U-shaped plate the user can bite on to fix his/her upper and lower arch in a unique bite position that allows the device to work. The bite plate is custom-fit to each individual's dental arch shape.
2. TRACK 12, a track fixed on top of the BITE PLATE to follow the individual's dental arch shape. It is possible to have the BITE PLATE and TRACK as one single part. Further, if the track is made of strong material, there is no need to have a bite plate.
3. CARRIER 13, powered by a motor, which holds the brushes. The carrier moves along the track.
4. BRUSHES 14, the brushes are placed on the carrier, which can be moved along the track. The brushes clean the user's teeth along the arch. The brushes can be powered by a different motor or have a translate gear to provide motion from the carrier. The brushes can be replaced after certain amount of usage.

The BITE PLATE 11 is positioned between the upper and lower teeth. The upper surface of the TRACK 12 and BITE PLATE tessellates the curvature of the occlusal and side surfaces of the upper teeth, and the lower surface of the TRACK tessellates the curvature of the top and side surfaces of the lower teeth.

FIG. 1 provides the TRACKS 12. One TRACK 12 is attached to the upper surface of the BITE PLATE 11, and the other TRACK 12 is attached to the lower surface of the BITE PLATE 11. These TRACKS 12 act as guides for the CARRIERS 13. The TRACKS 12 should be designed to occupy minimum space.

FIG. 1 also includes BRUSHES 14. The BRUSHES are mounted on each segment of the CARRIER 13. The BRUSHES focus on cleaning the side and occlusal surfaces of the individual's teeth. Each BRUSH is comprised of rows of bristles. The device's customized design allows the BRUSHES to be positioned to follow the tooth contour closely, and thus brush as effectively as possible.

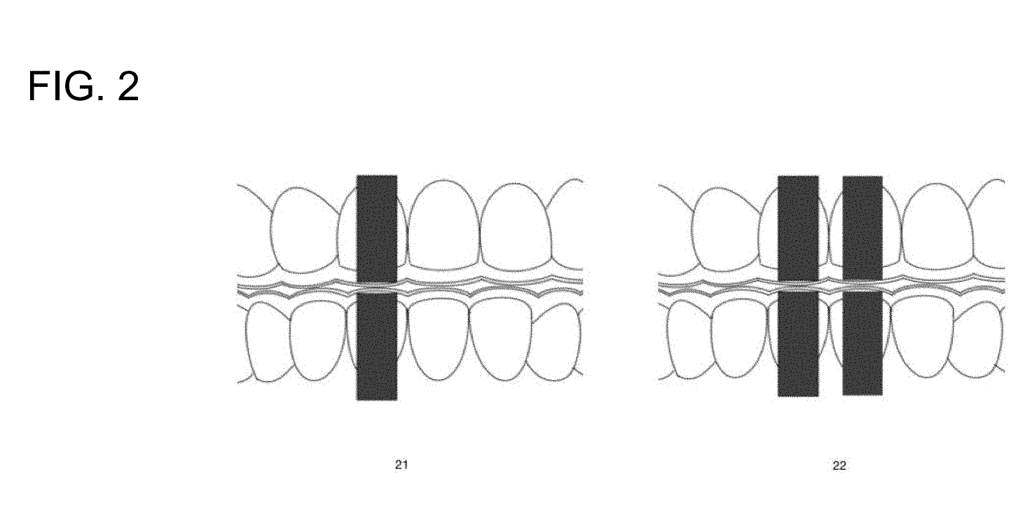

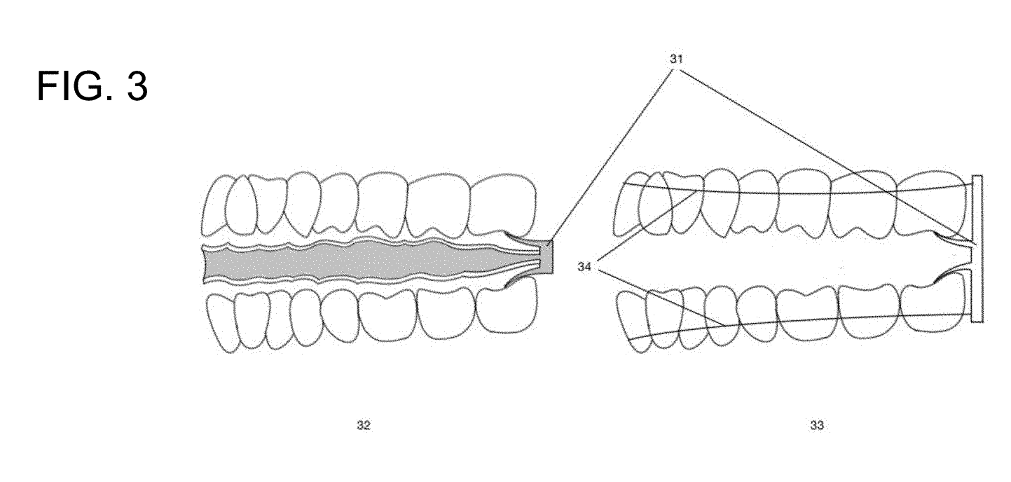

FIG. 2 shows two embodiments for the bite plate. The embodiment in 21 shows the device as comprised of one BITE PLATE, two TRACKS, one CARRIER, and one BRUSH. One of the TRACKS is attached onto the upper surface of the BITE PLATE and the other is attached onto the lower. Two pairs of CARRIERS carry one pair of BRUSHES each. Each pair of CARRIERS is pre-mounted onto the TRACK, and is set to begin at one end of arch to the other end. Once the user initiates the brush, e.g. presses a start button on the device, the CARRIER automatically moves along the TRACK, brushing the teeth from one end of one last molar, to the other end of the other last molar, and back.

The embodiment in 22 shows the device as comprised of one BITE PLATE, two TRACKs, two CARRIERS, and two BRUSHES. One of the TRACKs is attached onto the upper surface of the BITE PLATE and the other is attached onto the lower. Two pairs of CARRIERS carry one pair of BRUSHES each. Each pair of CARRIERS is pre-mounted onto the TRACK, and is set to begin at a central incisor. Once the user presses a start button on the device, each pair of CARRIERS automatically moves outward along the TRACK, brushing the teeth from each central incisor, to each respective pair of last molars, and back to the central incisors.

FIG. 3 shows two embodiments of the BITE PLATE 11 in side view.

Both embodiments have a narrow extension as shown in 31, which extends past each pair of last molars and comes back, resting at the surface of each pair of last molars. This extension to the BITE PLATE 11 serves two purposes. The first purpose is to hold the mouth open according to a pre-designed, fixed arrangement of the upper arch, lower arch and BITE PLATE 11. This arrangement enables the BRUSHES 13 to be positioned precisely, and brush along the exact tooth surface contour, which allows for maximum accuracy and thoroughness in brushing. The second purpose is to create enough room to allow the device to brush to the end of the last molars. To fulfill this purpose, one embodiment of 31 may be a mesh structure, which would allow more tooth surface to be exposed for maximum thoroughness in brushing.

The embodiment in 32 shows the BITE PLATE 11 placed between the upper and lower teeth. The TRACK 12 lies on the upper and lower surfaces of the BITE PLATE 11. The extension shown in 31 is located at the end of the BITE PLATE 11.

The embodiment in 33 shows the BITE PLATE 11 as only the extension shown in 31. 34 shows an embodiment of the TRACK, in which the TRACK is a wire which surrounds the occlusal surfaces of the teeth.

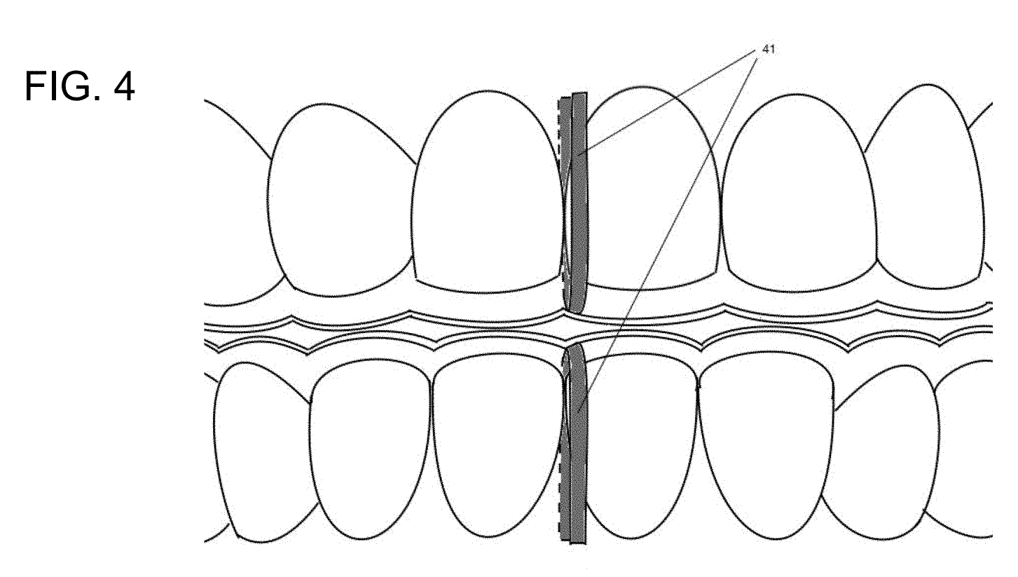

FIG. 4 shows an extension, located at the central incisors, to the BITE PLATE 11. A small U-shaped socket feature 41 replicates the negative of each incisor. This feature may be fixed on top of the TRACK, with one leg of the “U” at the front of the incisor, and the other leg, at the back of the incisor. It will allow for the incisors to be placed inside a precise socket, which will help elderly, children and disabled, as well as their caretakers, to secure the device easily, as well as reduce bite pressure from the molar extension, avoiding cracks in the device.

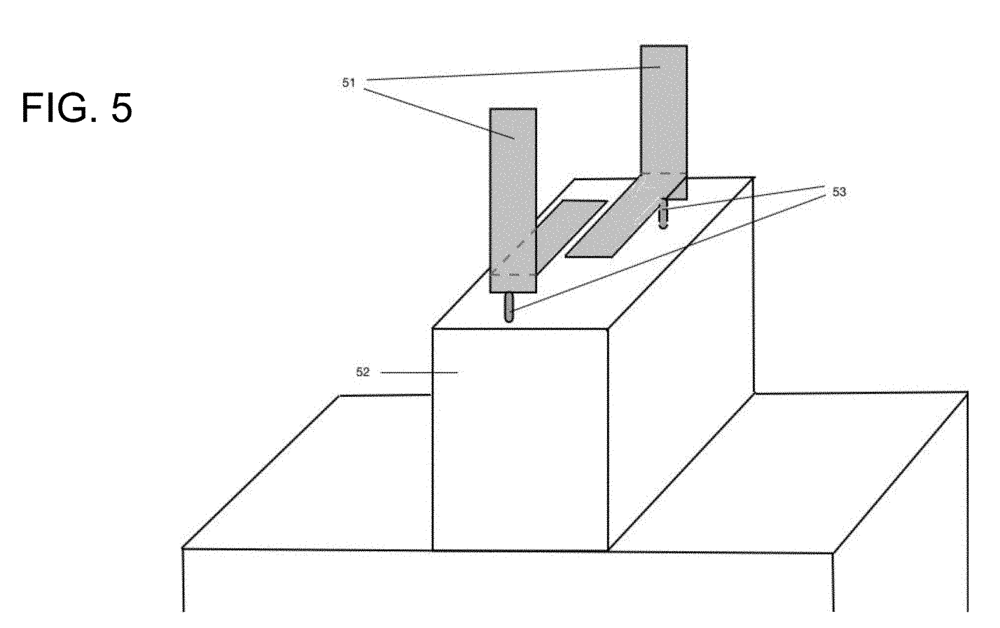

FIG. 5 shows the relationship between the CARRIERS 51 and TRACK 52. This relationship may be similar to that of a roller drawer slide and a desk, with the CARRIERS being analogous to the roller drawer slide and the TRACK, the desk. 53 shows the wheel attached to the bottom of the carrier, which allows the carriers to move linearly within the width of the track to accommodate the varying widths of the individual's teeth. The wheel is propelled by a motor to travel along the TRACK, and may have a counter or sensor to measure the traveling distance of the CARRIERS, to tell exactly which part of the user's teeth the CARRIERS are. This feature would allow users or their dentists to customize and control brushing to allot extended time to be spent brushing a specific part of the user's teeth.

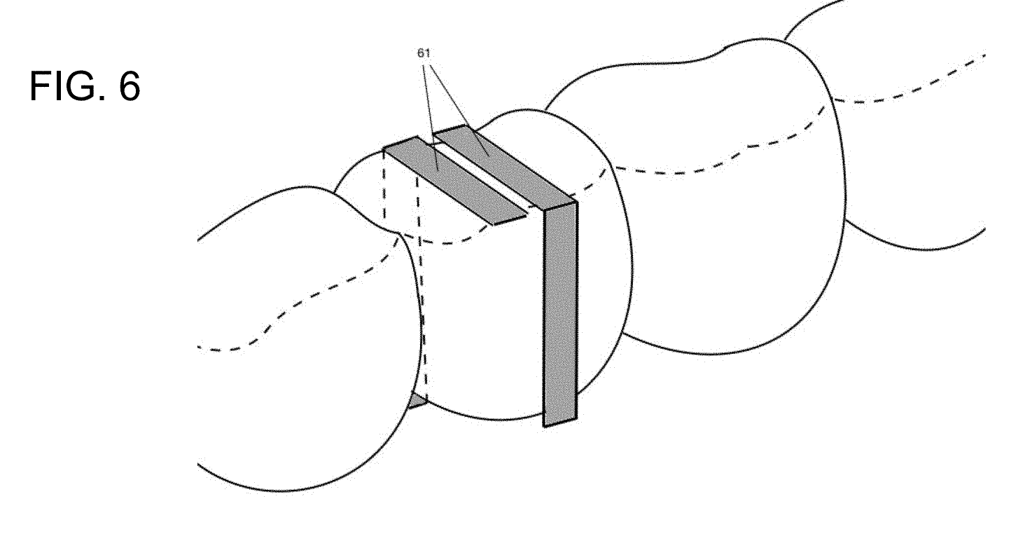

FIG. 6 shows the CARRIERS 61 as placed on the teeth. To ensure the BRUSHES clean both the side and occlusal surfaces of the user's teeth while also adapting to the tooth width when moving along the TRACKS, the CARRIERS 61 are recommended to be designed in pairs. Each CARRIER 61 is in an L-shape. The longer leg of the “L” is located on either side surface of the tooth, and the shorter leg of the “L” is located on the occlusal surface of the tooth. The two CARRIERS form a box-like arch that surrounds the tooth. Each pair of CARRIERS is positioned at default adjacent to each other in the middle of the central incisors. The CARRIERS 61 lie on the TRACK.

Once the user initiates brushing, e.g. presses a start button on the device, the two pairs of CARRIERS travel along the TRACK outwards towards the last molars, and back, as previously described.

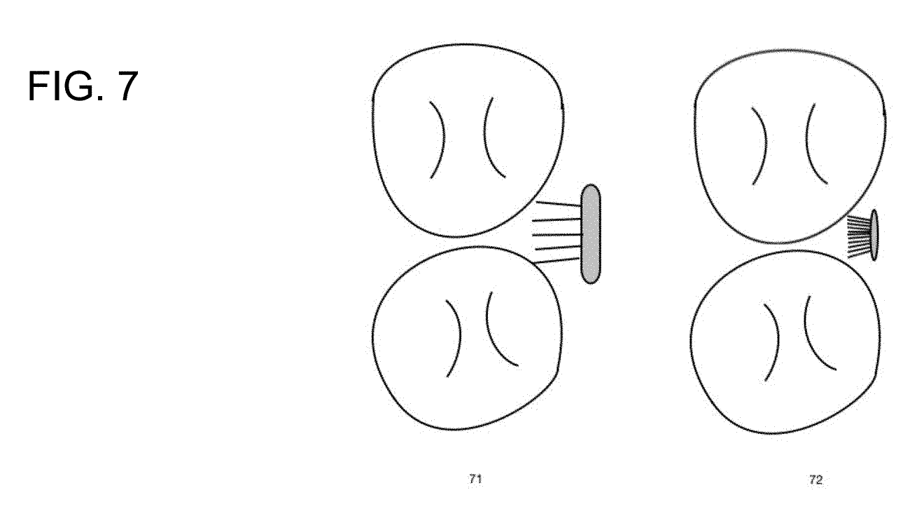

FIG. 7 shows a comparison of the conventional toothbrush and the device's BRUSH. 71 shows the conventional toothbrush, which cannot reach embrasure areas between teeth. 72 shows one of the device's BRUSHES. The device's BRUSH may be smaller, shorter, and have more bristles than the conventional toothbrush, allowing the BRUSH to reach embrasure areas more concisely.

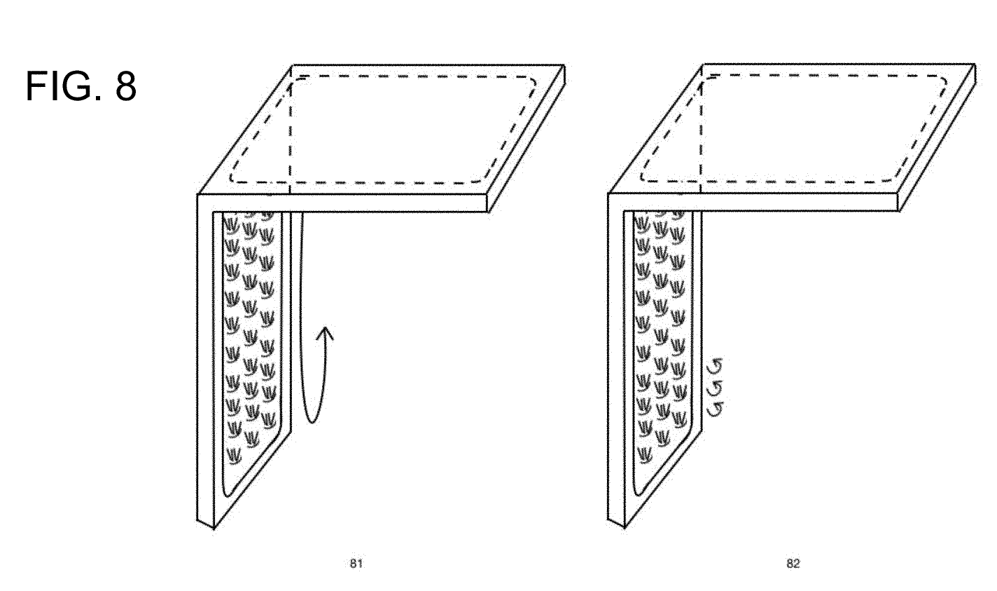

FIG. 8 shows two embodiments for how the bristles of the BRUSHES may rotate.

The embodiment in 81 shows the bristles as placed in multiple rows. The rows rotate as a singular entity in the same direction and at the same pace, in a manner similar to that of a conveyor belt.

The embodiment in 82 shows the bristles as placed in multiple rows. Each row rotates separately, in the same direction and at the same pace as the others.

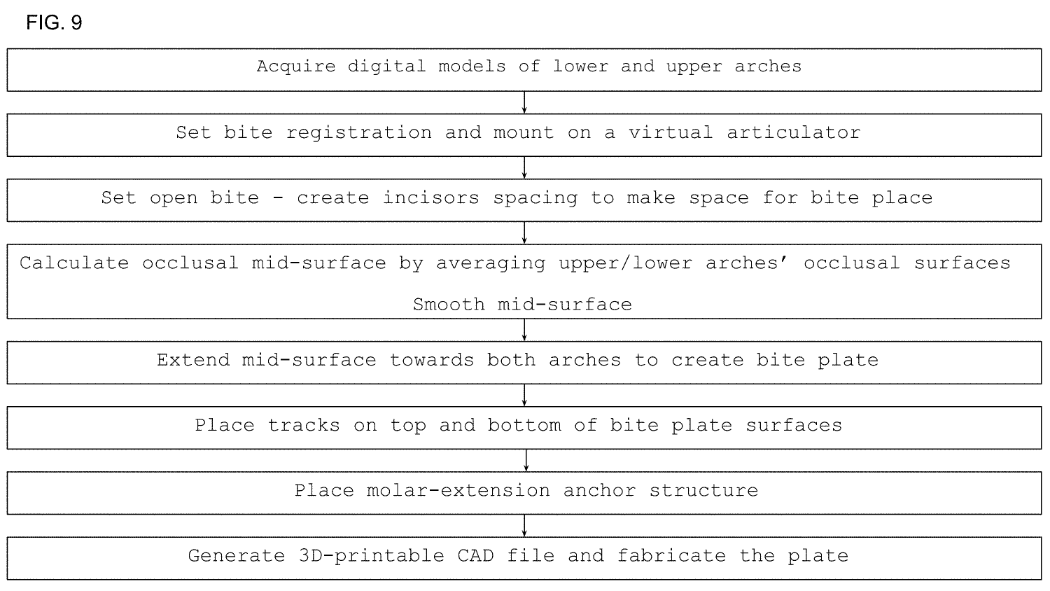

FIG. 9 shows an exemplary process to make a BITE PLATE and TRACK customized to an individual's dentition shape using CAD design and 3D printing technology. In order to make a customized toothbrush which can precisely adapt to each user's tooth shape, a user's dental impression is taken. This impression is then poured, forming a stone positive replica of the teeth. The teeth can be scanned by creating a CAD file using a desktop 3D scanner or an intraoral scanner such as iTero, 3Shape, or Carestream scanner. Once a CAD model of the user's teeth is created, it is imported to a proprietary BITE PLATE and TRACK design software. Afterwards, the lower and upper arches are set to their normal bite position. A virtual articulator is used to simulate the jaw and to design an open-bite position, creating enough space between the lower and upper incisors, leaving at least 5 mm of space to allow the designed BITE PLATE to be placed in between the upper and lower arches of the user's teeth. To customize the BITE PLATE to the user's teeth, the mid-surface of the occlusal surfaces of the user's upper and lower arches is calculated. The mid-surfaces are smoothed by removing sharp turns, allowing the device to move without jagged movements. The mid-surfaces are extended vertically equidistantly towards the upper and lower arches to create a solid BITE PLATE with a constant surface distance to the user's corresponding arch. The midlines of the upper and lower arches occlusal surfaces are calculated, and then projected to the top and bottom surfaces of BITE PLATE. The TRACK structure is laid out along these midlines. The standard molar extension structures are placed at the ends of BITE PLATE. Boolean subtraction is then done on the teeth geometry of the structures, creating perfect contact to the molars' surfaces, securing them. A 3D printable CAD model of the bite plate is then created and printed. Other methods, such as CNC milling, casting, wire bending, which may be useful if no bite plate is needed, can be used to produce a similar outcome. Finally, the CARRIER is inserted to the socket of the TRACK, and connected to an electric motor to provide power for both the BRUSH and TRACK moving wheels.

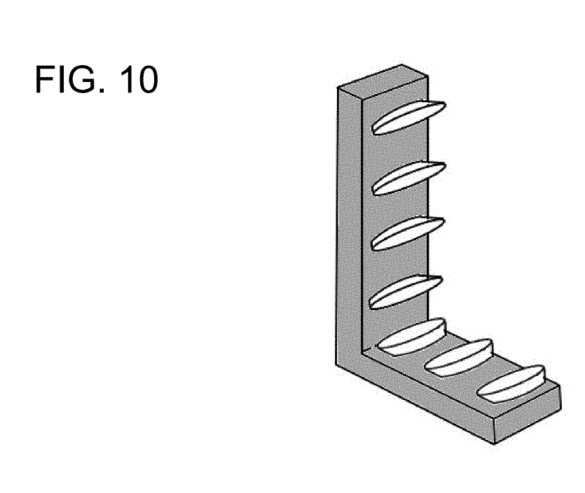

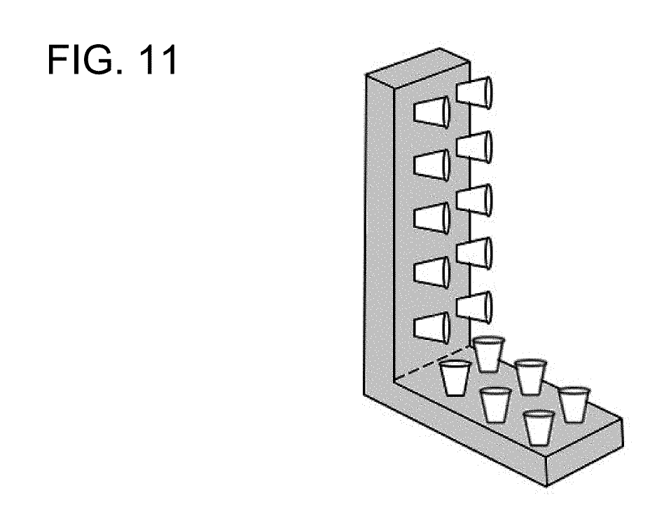

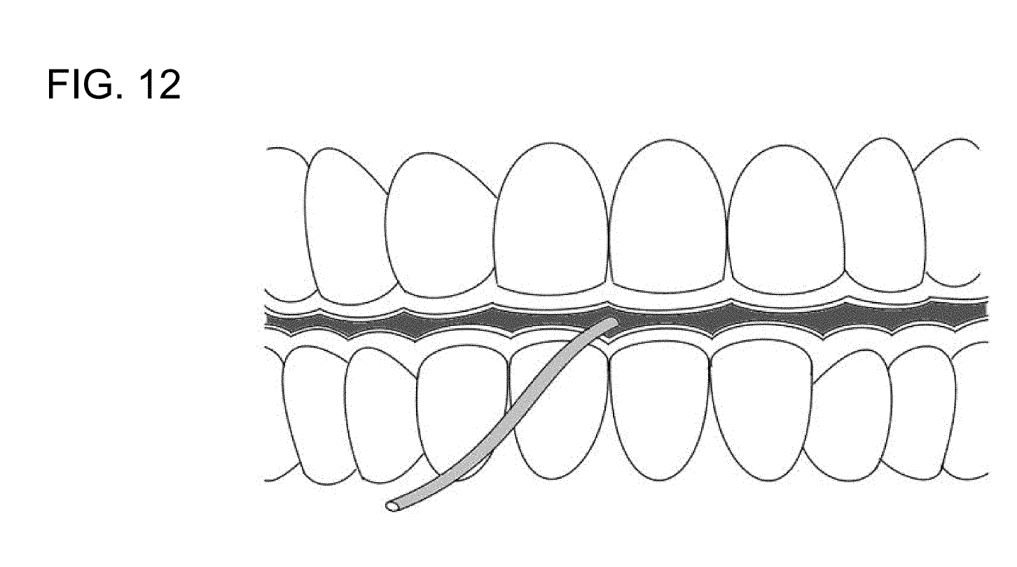

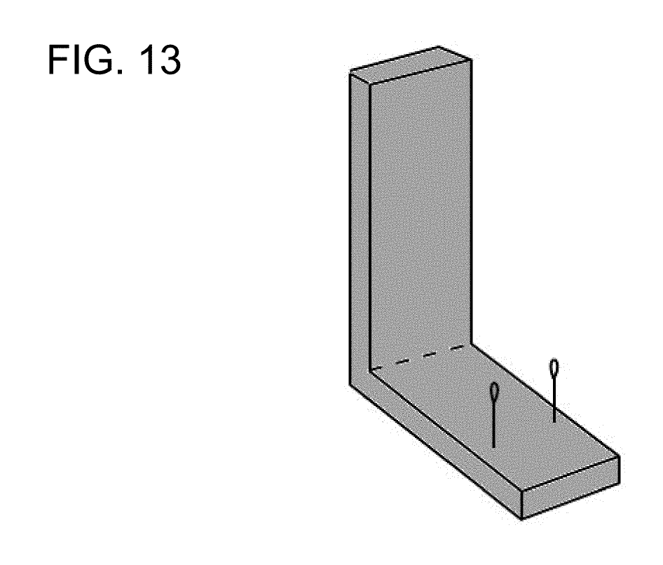

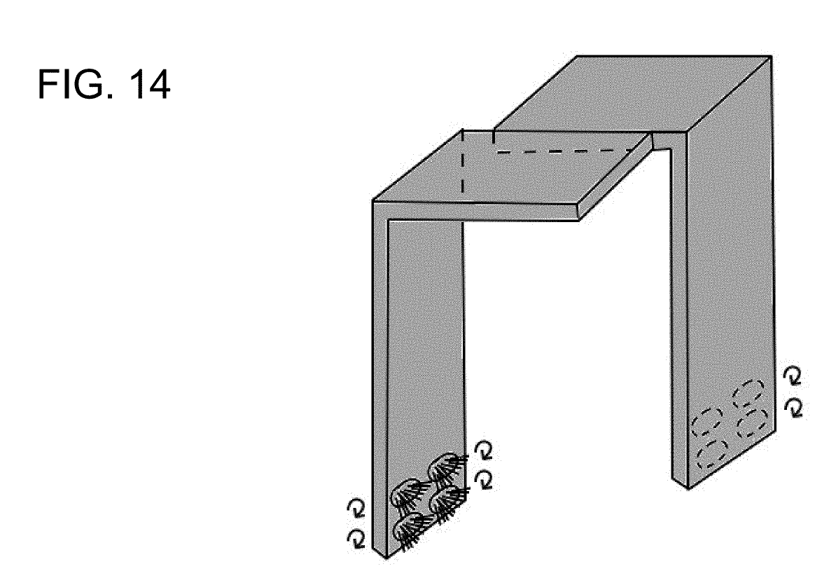

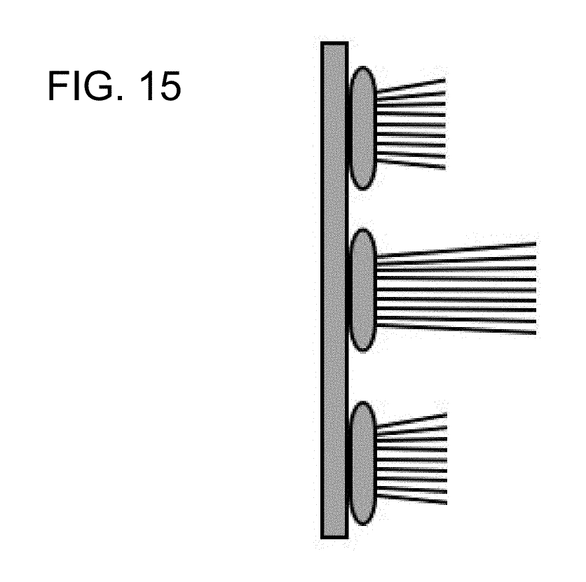

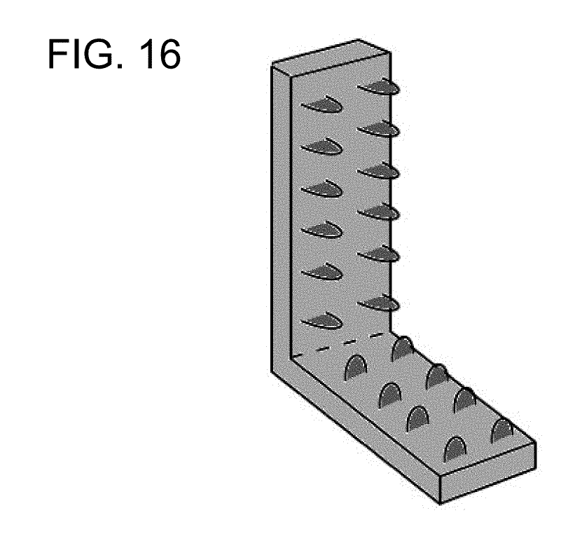

Unlike other electric toothbrushes, CARRIERS and BRUSHES move along the dental arches, following the exact curvature of each individual user's dental anatomy. This precise positioning is beneficial to produce other applications as well, such as the following:
TEETH WHITENING: FIG. 10 shows the whitening device by replacing the BRUSHES on the CARRIERS with nozzles, which can precisely apply whitening chemicals to the user's teeth surfaces. On the side of the nozzles, a UV light may be mounted as well. The device allows for whitening chemicals to be applied as precisely and concisely as possible, reaching all areas, including embrasures. In addition, the amount of chemicals applied can be controlled from area to area, avoiding too much or too little whitening chemicals applied to any given surface. If UV is applied, such precision placement will prevent the user from experiencing excessive UV exposure.
RINSING/MOUTH WASHING/Water Jet: FIG. 11 shows the mouth-washing and rinsing device by replacing the BRUSHES on the CARRIERS with water jet nozzles to apply water or a mouth-washing liquid to the user's teeth surfaces. FIG. 12 shows the drainage device, which is placed inside the BITE PLATE to rid of excess liquid in the user's mouth. This design allows for the liquid to be applied precisely and concisely, especially in hard-to-reach areas such as embrasures. In addition, the amount of liquid and pressure can be controlled from area to area, avoiding excessive drainage, and cleaning the user's teeth as effectively as possible.
FLOSSING: FIG. 13 shows the flossing device by replacing the BRUSHES on the CARRIERS with two flossing tips, which make sharp vertical movements to floss the teeth, much like a sewing machine. On one side of tip, a spool of flossing wire is stored, and goes up to the thread through the tip eye, similar to how a wire is threaded through the needle eye. The thread then goes through the tip eye to the other side, and secured. When the CARRIERS travel along the the user's dentition shape, the device knows exactly when it reaches an embrasure spot, locks the wire, then pulls the two tips low enough to ensure the wire reaches the ideal flossing depth. This motion can be applied multiple times to provide best flossing results, as controlled by the two tips. Motions may be but are not limited to vertical motion, horizontal motion, orthogonal motion, circular motion, or circulation. After the device finishes flossing one embrasure area, the wire can be pulled from the second tip to ensure a new fresh section of wire is available for the next tooth. Instead of tip eyes, which have round holes and harder to thread through wires, a C-shaped design which has an opening slot to snap wire from the side into the tip eye can be used as well.
GUM WASHING: FIG. 14 shows the gum-washing device by replacing the BRUSHES on the CARRIERS with bristles, mounted in a controlled rotation stage that works to clean the crevices between the user's teeth and gums, effectively cleaning the user's gums. It is important for a patient to receive regular teeth cleaning by a dentist, in part due to patients not having effective means of cleaning their gums, causing plaque deposits that may lead to a variety of oral hygiene diseases. To prevent this problem, an extension of the TRACK allows the device to focus on brushing the gums, as a preventive measure against gingivitis and other diseases prone to the gum areas.
BRUSHING THROUGH BRACES/RETAINERS: FIG. 15 shows the brushing device customized for users with braces or retainers by customizing brush lengths so that the device may reach difficult spots while other contraptions are in the mouth. The bristles are mounted in a controlled rotation stage, which helps clean difficult spots between the teeth, brackets, and/or wires, effectively cleaning the user's teeth while the user is undergoing other orthodontic treatment.
DRUG DELIVERY: FIG. 16 shows the drug delivery device by mounting the CARRIERS with small sockets holding mouth-borne drugs to allow for their gradual delivery. A sensor element detects the mouth environment, thus allowing for the controlled, precise, and concise delivery of drugs into the user's mouth. Such a sensor can be placed elsewhere, such as in another part of body, and sensing data can be transmitted wirelessly to control delivery from the socket.
   ANESTHESIA: This extension can also be used as an anesthesia device by replacing the BRUSHES on the CARRIERS with rubber tips to apply anesthetics precisely to the user's mouth. The advantage of this design is anesthetics can be applied precisely, sometime multiple times when necessary. Doctor can use a mobile app to describe how he wants the anesthetics be applied, and the app controls the anesthesia device to apply precisely following the instruction.
   ALLERGY TESTING/RESISTANCE DEVICE: This extension can also be used for allergy testing and resistance device by mounting the CARRIERS with small sockets that can hold mouth-borne allergens in miniscule and controlled amounts, at a delivery pace customized to the user's tolerance level. A sensor element detects the mouth environment, thus allowing for the controlled, precise, and concise delivery of drugs into the user's mouth. Such a sensor can be placed elsewhere, such as in another part of body, and sensing data can be transmitted wirelessly to control delivery from the socket.

Similar to other wearable devices, the device has its own Smartphone App, to better TRACK and manage device utilization.

The device's smartphone app serves the following functions:
allows users to create accounts
allows dentists to modify the user's device's brush time at any specific area of the patient's teeth.

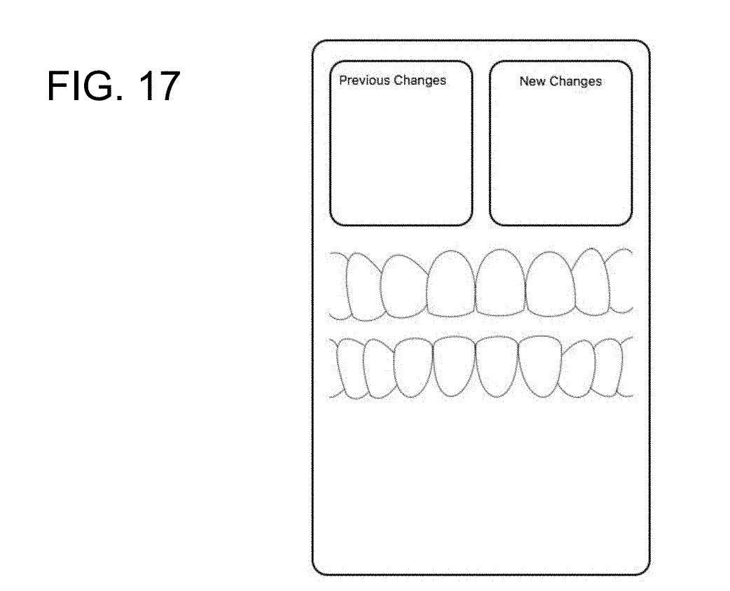

FIG. 17 shows a screenshot of the application in which the dentist can control brushing time for a specific area of the user's teeth. This information is then wirelessly transmitted to the device's control unit. When the device reaches the focus area specified by the dentist, the device acts according to the dentist's instructions.
allows multi-user progress-TRACKing of:
   brushing history
      date
      start/end time of day
      total brushing period per use of the device
   dentists' modifications
      displayed on a 3-D visual guide of the patient's mouth
      displayed in list form
   upcoming dental-related appointments
allows parents, caretakers, dentists, and others to review brushing history remotely
allows anyone with access to the account to receive notifications of dentists' modifications to the user's device

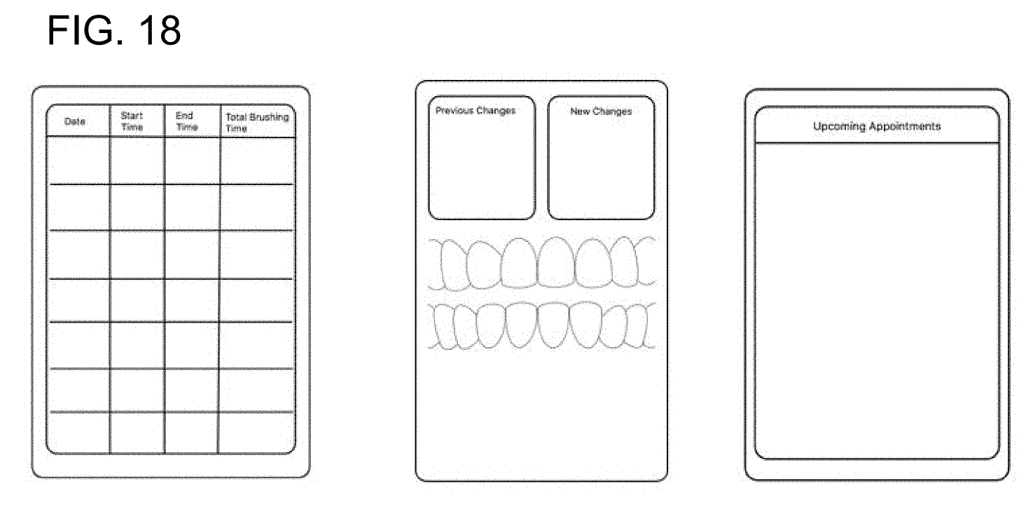

FIG. 18 shows a screenshot of the application in which anyone with the user's account information can TRACK a user's progress with the device, customizations to a user's the device by his/her dentist, and a user's upcoming dental appointments.

While the invention has been described and illustrated as embodied in preferred forms of construction, it will be understood that various modifications may be made in the structure and arrangement of the parts without departing from the spirit and the scope of the invention recited in the following claims.

What is claimed is:

1. A cleaning device, comprising:
a bite plate to clamp an upper and a lower arch in a predetermined bite position;
a track fixed to the bite plate to provide a dental arch movement; and
a carrier holding dental instruments thereon and moving along the track.

2. The device of claim 1, wherein the bite plate is custom-fit to each individual's dental arch shape.

3. The device of claim 1, wherein the bite plate comprises a U-shaped plate.

4. The device of claim 1, wherein the BITE PLATE and TRACK comprise one single part.

5. The device of claim 1, wherein the instruments comprise brushes.

6. The device of claim 5, wherein the brushes are replaceable. The device of claim 1, wherein the instruments comprise jets.

7. The device of claim 1, wherein the instruments comprise nozzles to provide a liquid jet at a tooth.

8. The device of claim 1, wherein the instruments deliver medication.

9. The device of claim 1, wherein the instruments deliver a teeth whitener solution.

10. The device of claim 1, comprising a motor to move the carrier along the track.

11. The device of claim 1, comprising a liquid drainage device placed inside the bite plate.

12. The device of claim 1, wherein the instruments comprise a flossing device.

13. The device of claim 1, wherein the instruments cleans teeth with braces or retainers.

14. The device of claim 1, wherein the instruments deliver medication.

15. The device of claim 1, comprising a second track, wherein one track is attached to the upper surface of the bite plate and the other track is attached to the lower surface of the bite plate.

16. The device of claim 1, wherein the bite plate is

17. The device of claim 1, wherein an upper surface of the track and bite plate tessellates a curvature of an occlusal and side surfaces of upper teeth, and a lower surface of the track tessellates the curvature of the top and side surfaces of lower teeth.

18. The device of claim 1, comprising a motor to drive the carrier.

19. The device of claim 1, comprising a motor to drive brushes on the carrier.

20. The device of claim 1, comprising an application where a dentist controls brushing time for a specific area of teeth.
